(19) United States
(12) Patent Application Publication
(10) Pub. No.: US 2006/0195696 A1
(43) Pub. Date: Aug. 31, 2006

(54) Method and apparatus for enhanced audio/video services with watermarks and associated data

(75) Inventors: Mark A. Hollar, Palo Alto, CA (US); Peter Wonfor, El Granada, CA (US)

Correspondence Address: MORRISON & FOERSTER LLP, 755 PAGE MILL RD, PALO ALTO, CA, 94304-1018, US

(73) Assignee: MACROVISION CORPORATION, Santa Clara, CA (US)

(21) Appl. No.: 11/404,197

(22) Filed: Apr. 13, 2006

Related U.S. Application Data
(62) Division of application No. 09/505,621, filed on Feb. 16, 2000.
(60) Provisional application No. 60/121,806, filed on Feb. 25, 1999.

(51) Int. Cl. H04L 9/00

(52) U.S. Cl. 713/176

(57) ABSTRACT

Method and apparatus for controlled copying of an audio or video signal transmitted over a cable television or direct satellite broadcast system or the internet. Copyrighted (or other) audio or video material is protected from unwanted copying (recording) by the combination of a watermark embedded in the audio or video signal at the head end together with additional copy protection data inserted in the audio or video signal, either a ticket or a second watermark. Video line 21 in the vertical blanking interval for (NTSC TV) is used to hold the ticket (cryptographic counter). An audio or video watermark is embedded in the active portion of the audio or video signal. Only if the consumer is willing to pay a fee is the video signal with both the watermark and the ticket transmitted to his recording device which then matches the watermark to a mathematical function of the ticket, and only if they match is recording permitted. Alternatively, this consumer control may operate on a second watermark in the audio or video. The corresponding playback device outputs an audio or video signal which does not have the ticket and hence no further copying is permitted. This enables a single copy to be made upon payment.

### FIELD OF INVENTION

This disclosure relates to audio and video and to enhanced audio and video services, such as pay-to-record or pay-to-tape, in, e.g., a cable television system, direct broadcast satellite system, or public computer network (internet).

### DESCRIPTION OF THE PRIOR ART

Some methods of controlling copying, or preventing serial copying, of video material with a video watermark rely on the recording device to add a second watermark to the video image. Watermarks are well known in the digital video field. Watermarks are signals embedded in an otherwise conventional video or audio signal that provide a unique identifier and thus discourage or prevent unauthorized copying or use. The watermark is not apparent to a person viewing the watermarked signal, but is readily detected by appropriate circuitry.

Preventing or controlling copying is useful to prevent copyright infringement, and prevent distribution of unauthorized copies. In a “generational” control system where there is a one-copy-allowed state and a no-more-copies-allowed state, the combination of first and second watermarks define the no-more-copies-allowed state while the original watermark defines the one-copy-allowed state. (Copying here refers to use of a video tape recorder or video disc recorder, for instance.) In a television system with a digital cable television or direct broadcast satellite set top box (STB), this type of system prevents serial copying of video content, since the compliant recorder makes the appropriate state change from one-copy-allow to no-more-copies during the record process. However, it does not easily allow for a pay-to-record feature since records are generally not provided with back channel and communication mechanisms for reporting purchase choices to an accounting system.

To implement a pay-to-record feature, the STB needs to control the state change rather than the recorder controlling the state change. The pay-to-record feature thus allows a STB to output video under conditional access control with three possible payments by the viewer: No payment: the consumer (viewer) is not allowed to view or record the content; One level of payment: the consumer is allowed to view the content, but is not allowed to record it. Different (higher) payment: the consumer can both view and record the content. While it is possible to use the STB to introduce the second watermark, there are “legacy” issues that prevent widespread adoption of such a system. Specifically, there is a large installed base of STBs which do not incorporate the required features to allow this second watermark to be added. If a copy control system were introduced which used such a second watermark for copy control in STBs, then the existing consumers with STBs without this feature would be disenfranchised; those consumers would be unable to make copies at all.

An alternative method of providing these copy control features uses a “ticket.” A ticket here is a cryptographic counter (number, usually in binary form) which is carried in a communications channel associated with the video. This ticket uses one-way cryptographic features to maintain a play and record history. One way functions are well known to those versed in the cryptographic field and include a class of transforms with the property that the function is relatively easy to compute but significantly harder to undo or reverse. In other words, given x it is easy to calculate f(x), however given f(x) it is difficult to compute x.

A recorder detecting the one-copy-allowed state's watermark must then detect the correct ticket prior to allowing a recording to be made. To convey the ticket from the STB to the recorder, the vertical blanking interval (VBI) of the video signal can be used as a communications channel. However, this has the disadvantage that some broadcast MPEG encoders (video compression devices) do not transmit the entire VBI. Alternatively, the ticket is inserted in the active picture area, such that it is in the overscan area of older TV's. However, this has the disadvantage that this data may be seen by the viewer on newer TV's (having less overscan) and thus may be deemed objectionable by the consumer.

Yet another method of conveying the ticket is to activate and de-activate a subset of the analog anti-copying protection system signals to convey a bitstream. (Analog anti-copying protection signals here refer, e.g., to the Macrovision Corp. video copy protection processes which are commercially available; also see, e.g., Ryan U.S. Pat. No. 4,601,603). This has the advantage that existing digital recorders such as those of the DVCAM type automatically delete this form of a ticket, since they fail to record the VBI. However, to accomplish the appropriate control out of the STB requires changes to the STB's internal software. In some cases, this software can be downloaded to existing STBs over the air or cable. In this manner the encoder IC (integrated circuit) which generates the Macrovision Corp. analog copy protection pulses can react appropriately. However, in other cases the internal software has been installed permanently in the STB and cannot be modified.

All these methods of transmitting a ticket require modification to the cable-TV/satellite system head end control software to provide a way to introduce the ticket into the video. This modification could undesirably be quite expensive to the cable-TV or satellite system operator.

### SUMMARY

This disclosure is directed to use of a watermark together with consumer controllable information in a television (or audio only) STB to provide pay-to-tape (or pay-to-record generally) control. One embodiment uses the existing video line 21 (in NTSC-TV) extended data service or closed caption protocol to hold a ticket (cryptographic value), and a video watermark, to jointly control copying of video being provided by a STB. This may be done in such a manner to enable additional features, such as pay-to-tape or pay-to-record, even in systems with prior art (legacy) STBs. In addition, this approach has the advantage that existing cable-TV or satellite system head end MPEG (compression) encoders can already transmit this type of information. Hence minimum changes are required to the system operator's infrastructure.

### BRIEF DESCRIPTION OF THE DRAWINGS

FIG. 1A shows a block diagram of a system in accordance with the disclosure; FIG. 1B shows detail of FIG. 1A; FIG. 1C shows a variant of FIG. 1A; FIG. 1D shows a variant of FIG. 1C.

FIG. 2 shows playback in accordance with this disclosure.

FIG. 3 shows a video recorder for the FIG. 1A system.

FIG. 4 shows a block diagram of another system.

FIG. 5 shows a video recorder for the FIG. 4 system.

FIG. 6A shows the system of FIG. 1; FIG. 6B shows a combination STB and recorder.

FIG. 7 shows the system of FIG. 4 modified for audio.

FIG. 8 shows an audio recorder for the FIG. 7 system.

### DETAILED DESCRIPTION

This disclosure is of a system which in one embodiment utilizes the existing infrastructure and legal advantage given to video line 21 (in the VBI in NTSC-TV) data and combines it with a new aspect available with video watermarks to generate revenue by allowing controlled copying of video signals. Video line 21 (in NTSC TV, which is the U.S. television standard) currently is used to carry closed caption data and parental blocking (V-chip) data in accordance with two significant standards: ANSI/EIA-608 and ANSI/EIA-744. (Other television standards have similar features and may be used similarly.) In particular, various U.S. laws require television sets sold in the U.S. to react to data carried by line 21 and require the data on line 21 to be preserved during transmission through various paths. In addition, U.S. FCC rules derived from the U.S. Telecommunications Act of 1996 also require TV receivers or PC's (personal computers) with video tuner cards, and with displays greater then 13″ in size, to provide parental blocking (V-Chip control).

The legal requirement (in the U.S., at least) to provide parental blocking ensures that PC's (personal computers), as a potential class of storage/recording device, must recognize video line 21 data. Without this legal requirement, PC's might make that bandwidth/capacity available for other functions. As described in EIA-608, field 1, line 21 is allowed only to have closed captioning or the original picture content. (TV pictures have two fields per frame.) No other data services are allowed here. Field 2, line 21 may however have closed captioning, parental blocking or other extended data services. The protocol provided with extended data services is flexible enough that the protocol can accommodate a ticket (or other associated data) as described above.

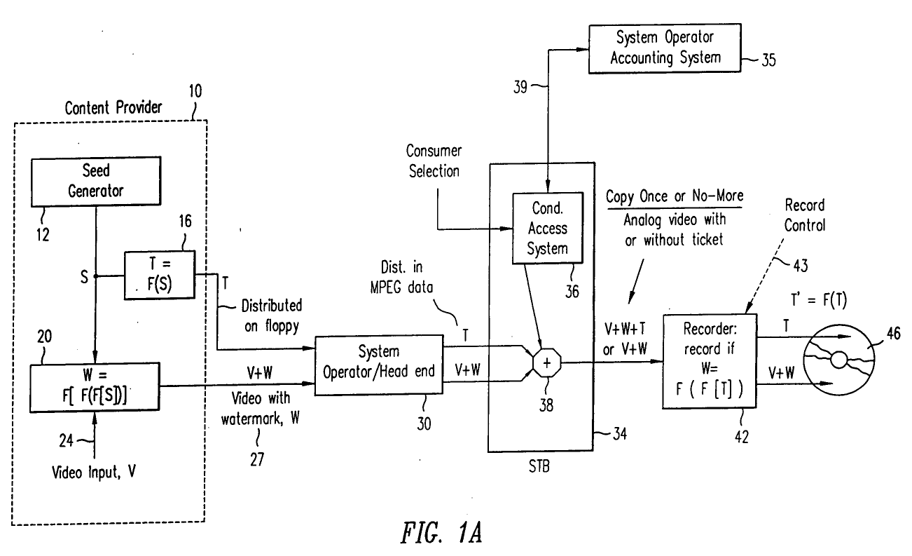

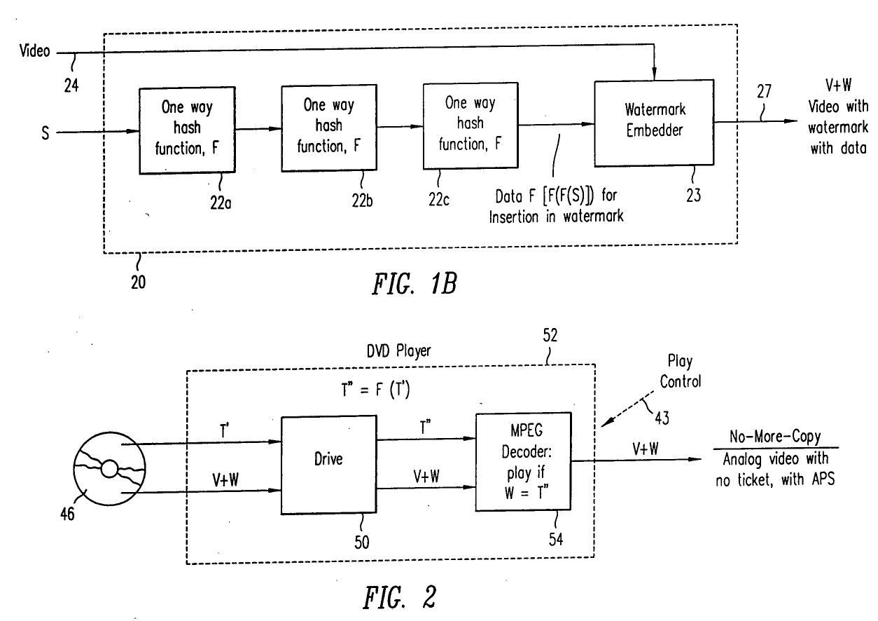

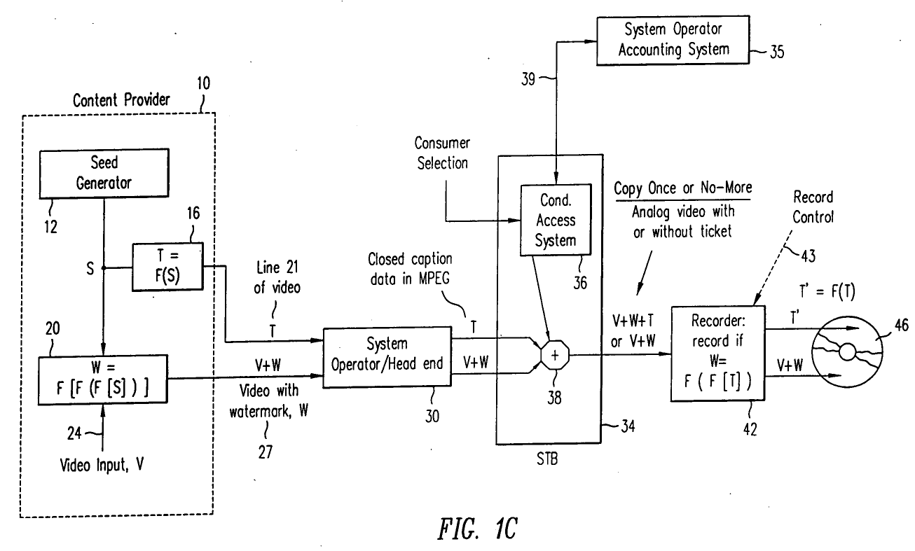

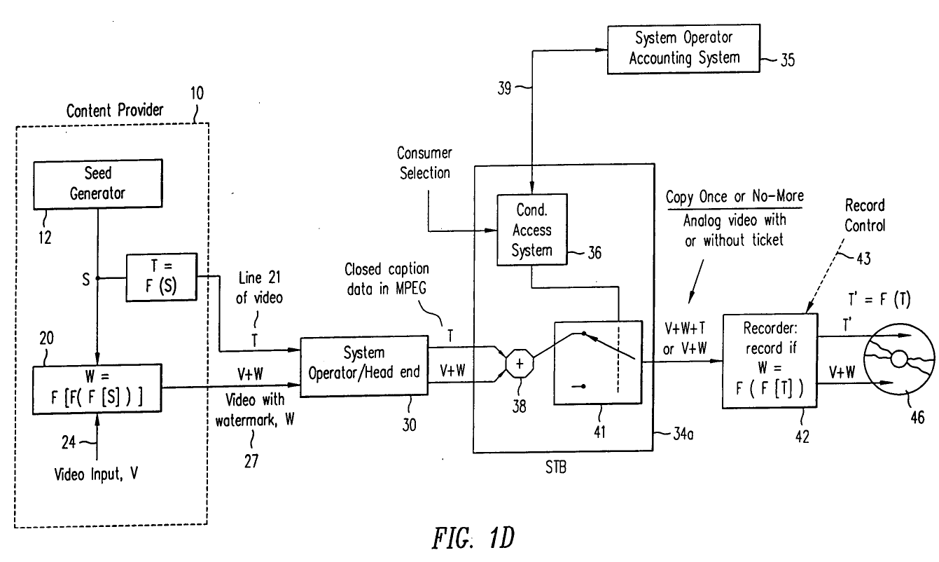

To follow the path of the ticket as shown in FIG. 1A, at the time of content (program) preparation by the content provider 10, a seed (number) S is generated by a seed generator 12. (This is, e.g., a random number generator.) This seed S is then subject to a fixed and secure one-way hash function F by hash function element 16. This is a one-way hash (compression) function of the type well known in the cryptographic field to determine the original ticket T. The system operator cannot reliably be known to be a trusted party; as such, making the seed accessible to him has the potential to weaken the system security. Hence in this embodiment the content provider, not the system operator, does this. In addition, the seed S is provided to the watermark embedder 20.

Note that this is a hybrid digital-analog TV system. Upstream of the STB 34, the signal is digital; the STB outputs an analog signal or optionally both a digital and analog form of the video signal. Signal transmission over other channels (e.g., the internet) is an alternative.

Each block in the figures represents a conventional integrated circuit or commercially available component (circuit or software) or product or such a conventional element modified as disclosed here; the nature of the connections therebetween as shown in the figures, and any necessary modification thereto, will be apparent to one skilled in the art in light of this disclosure. For instance, the content provider block 10 could be embodied in a suitably modified computer, with the seed, ticket and watermark generation carried out by software executed by the computer's central processing unit.

The watermark embedder 20 submits the seed S recursively to the function F three times, as shown in detail in FIG. 1B, to generate a watermark W which is then conventionally added to (embedded in) the video signal V applied at video input port 24. As shown in FIG. 1B, watermark embedder 20 includes the three one way hash function F blocks 22a, 22b, 22c and element 23, which inserts the resulting data F[F(F(S))] as the watermark in the video. The output signal of embedder 23 is on line 27, also shown in FIG. 1A. The watermark is added in a linear or non-linear fashion using any available watermarking technique. In some cases, to convey a sufficient number of bits to guarantee a ticket of appropriate cryptographic complexity, the ticket is transmitted as a series of characters varying over time. These digital communication methods for conveying m-bytes of data across an n-bit wide interface are well understood, and can use any available protocol, including, for instance, TCP/IP or PPP.

The video signal with the watermark V+W and the ticket T can be independently transmitted to the system (cable or satellite TV) operator/head end 30, or optionally the content provider can use a standard closed captioning encoder to embed the ticket T on, e.g., video line 21. (The distinction here between the content provider and system operator is arbitrary and only for purposes of illustration.) An example of a method of independent transmitting the ticket T to the system operator would be to provide it on a floppy disk. The system operator could then send it through the system as MPEG user data.

The line 21 method of distributing the ticket, as seen in FIG. 1C, has the advantage that it allows the system operator to deploy the watermark/ticket addition system at its head end 30 with no changes to the remainder of its existing infrastructure. (FIG. 1C is otherwise identical to FIG. 1A.) In this second case, the (ticket T) data on line 21 of the video is extracted from the video signal and sent as MPEG data by the system's MPEG encoder. Without this, line 21 would be treated like video and would potentially be subject to the usual video compression artifacts, as transforms like the discrete cosine transform are applied, quantizations are made and bit rate reduction occurs. This undesirably would corrupt the ticket.

In FIG. 1C, from the system operator's head end 30, the ticket T is conveyed as line 21 MPEG data in the MPEG stream's video elementary stream while the video with watermark V+W is sent as compressed picture data. The ticket T is provided to all STBs 34 via conventional broadcast and reception of the MPEG data stream.

Two classes of STBs 34 must be considered: legacy (old) STBs and new (upgraded) STBs. Legacy STBs are unable to have their internal microcontroller software upgraded. Thus they treat the ticket T on line 21 as standard closed caption, teletext or extended data. All of this information which is provided to the STB is output in the analog video signal as line 21 data.

Consumers with legacy STBs are not inconvenienced or prevented from making a recording. This is a disadvantage from the content provider's standpoint, since he may in fact accrue less revenue as a result. However, television industry practice with respect to time shifting (video recording) may indicate that such consumers should not be disadvantaged. Thus the system as described here ensures that the consumer is in fact not disadvantaged and that legacy STBs provide the ticket on their video output. As shown in FIGS. 1A, 1C and 1D, the STB 34 outputs the video with the watermark with the ticket, V+W+T. In the case of FIG. 1D, the ticket T is not controllable by the consumer due to the “legacy” design of the STB 34a. Here the only possible user control is pay-and-view or not-pay-and-not-view. This is controlled by the switch 41 shown in the STB 34a of FIG. 1D.

New or upgraded STBs in accordance with this disclosure provide additional control to the consumer and also allow accrual of greater revenue for the system operator and lot content provider. In this case, the consumer can select whether he wishes to simply view the program or whether he wishes to view and record/store it. When he makes his selection through a standard interface with an onscreen display and remote control, the STBs conditional access (CA) sub-system 36 stores an indicator of the activity—view only or view and record—which the consumer selected.

This indicator is transmitted to the system operator via a conventional cable/satellite TV/internet return path 39 (FIGS. 1A, 1C) which includes, e.g., a telephone modem using the telephone lines or, in those cable TV systems which support it, a conventional cable plant return path. Return path 39 allows the system operator to charge the consumer for his selection. A report of the access is made to the conventional system operator accounting system 35 for consumer billing purposes, via return path 39.

After the conditional access sub-system 36 has stored the indication of the consumer's request, then the addition of the ticket T to the video occurs. If the content is only to be viewed, then the video is provided out of the STB 34 without the ticket: V+W. If the content is to be viewed and recorded, then the video is provided out of the STB 34 with the ticket: V+W+T. Adding the ticket T to the video V consists now of either introducing the ticket data T in the encoder IC (integrated circuit) in the STB 34 or alternatively in an ATSC RF remodulator integrated circuit located in STB 34. It is this encoder IC which outputs an analog video signal to the associated TV receiver (not shown) connected to STB 34 based on the input digital video signal. It is the RF remodulator which outputs an ATSC digital TV signal. In this case, the ticket T is controllable by the consumer via his STB 34.

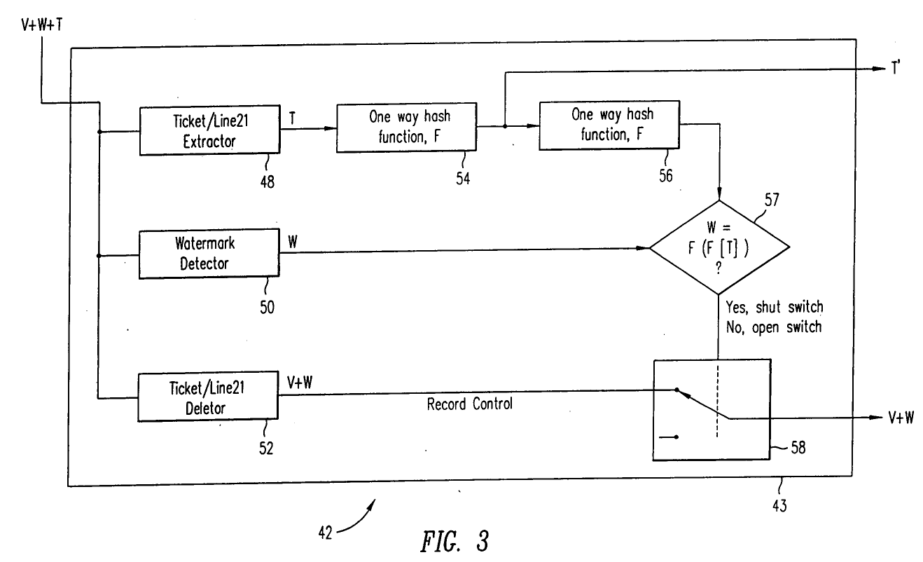

In FIGS. 1A and 1C the recorder 42 now receives the analog video signal V+W or V+W+T. Video recorder 42 (portions of which are shown in detail in FIG. 3) is mostly conventional but adapted as disclosed here to include the record control function 43. Ticket/line 21 data extractor 48 extracts the ticket T and submits it to circuitry (processor) 54, 56 which performs the one-way hash function F two times on ticket T. If the result of this hashing at 54, 56 matches, at comparator 57, the watermark W in the video signal detected by a watermark detector 50, then switch 58 is closed and recording by recorder 42 is allowed, i.e., recording is allowed when the following conditional logic statement is returned as being true:
W=F(F[T])

As shown, switch 58 (when closed), controlled by comparator 57, couples the V+W signal extracted by the ticket/line 21 detector circuitry 52 to the output terminal of switch 58. This output signal V+W is then coupled to the actual recording part (not shown) of recorder 42, which is conventional.

The pay-to-record feature has now been implemented. If there is no ticket T detected by the record control 43 recorder 42, then this statement (comparison) is returned as no. This would be the case if the consumer had chosen to only view the content. If the wrong ticket T is accompanying the video, perhaps because a recording of the video signal has already been made, then again the statement is returned as false and the recording is not permitted. (Note that recorder 42 need not be a digital recorder.) When recording the video and ticket to the recorder media 46 (in this case the media is a disc as shown in FIG. 1A), the ticket T is again subject to the function F to generate a new version of the ticket T′. In this case the cryptographic counter has been incremented: T′=F(T)

Later when playing back the video content from the recording media 46 as shown in FIG. 2, circuitry associated with the drive 50 in the player 52 (e.g., a DVD player) again increments the ticket T by applying function F to it: T″=F(T′). The drive 50 performs this function, e.g., when a DVD player 52 is implemented as a drive in a personal computer with a software or hardware associated MPEG decoder. (Note that there is no requirement for a drive and rotating media; the media may be, e.g., semiconductor storage with appropriate access circuit circuitry.) In any case, there is conventionally an interface (the drive or semiconductor storage control circuitry) to the actual recording (storage) medium.

Then the drive (or appropriate circuitry) performs the ticket incrementing to enhance security. (The player 52 may be the recorder 42 of FIG. 1A or a play only device.) Now at the MPEG decoder 54 in the player 52, the watermark W is again detected and checked against the current ticket T″. If a match is found, then playing is allowed and play control is implemented. In this case, the following equation must hold:
W=T″=F(T′)=F(F(T))

An additional option under play control (also shown in FIG. 2) at this point is to apply to the video signal an analog video copy protection of the type available from Macrovision Corporation, such as automatic gain control and/or color stripe. This has the advantage that further VHS analog video copies are prevented (or at least are not usable) as well as the additional digital copies which are worked upon by equipment with watermark detectors.

The watermark described herein can be implemented in a number of different ways, depending on the capability of the associated watermarking system. For instance, if the watermarking system that is available is able to carry sufficient data on a single field, then a sufficiently large amount of data can be carried such that no time varying mechanisms need be applied. In some embodiments the watermarking system carries 8-bits per frame; however only 4 bits are available for hashing seed purposes since 4 bits were needed for other uses. For security reasons it is desirable to use a 64-bit seed and 64-bit tickets. Thus, these embodiments require a minimum of 16 frames with the actual number of frames dependent on the transport protocol employed based on the digital communication system design. Thus one embodiment requires typical communication protocols such as PPP which employ start and stop characteristics. Due to the nature of a video communication channel, it may be desirable to employ some form of forward error correction. Reed-Solomon encoding is one example of a forward error correction code that is commonly used for this purpose.

Some embodiments also employ 16-bits per field when carrying the ticket on line 21. Thus, both the ticket processing and watermark processing require buffers for storage such that decisions can be delayed and timed to occur when whole data values are available. Design of these types of buffers is apparent to those in the video and digital communications fields in light of this disclosure.

While the above disclosure is of a method using line 21 of analog video to carry the ticket between the STB and recorder to enable pay-to-record features, any combination of a watermark and consumer controllable information in an STB could be used. This approach is also not limited to any particular TV standard. In particular, other video lines could be used to hold the ticket as long as they have the desired characteristics of being transmitted to the STB in a manner such that they can be controlled by the consumer through the STB.

In addition, if the video is being transmitted over a digital interface, such as IEEE-1394 (“Firewire”) or an ATSC (high definition TV) 8-VSB signal, from the STB to a device (recorder) which has storage capability then the ticket can still be controlled in the STB. In this case, the transmission or lack of transmission of the correct ticket is accomplished and the watermark/ticket combination still defines the copy-state. In these situations, the ticket could be transmitted using the MPEG User_data descriptor. In some cases, it may be desirable to not transmit any ticket at all, but in other cases, it may be desirable to transmit an incorrect ticket.

There are also other places in these video signals which could be used to transmit the ticket; however, the ticket is still controlled in the STB. The STB provides a way for ensuring that the content owner receives payment, whether that payment is for viewing only or for viewing and recording. Thus, it is the watermark and associated data under consumer control in the STB which are used in this method.

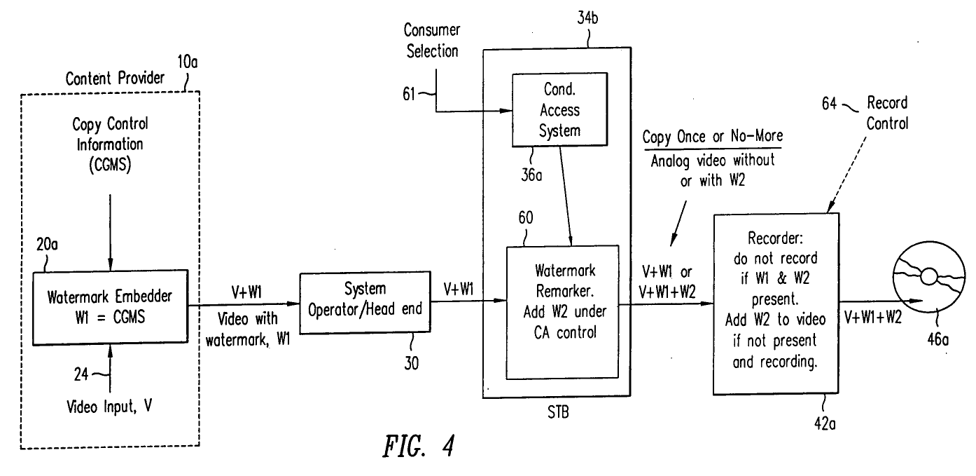

Another embodiment (see FIG. 4) uses a second watermark embedder located in the STB 34 as a watermark remarker 60. (No ticket is used here.) In this method of creating video and record or view only video, a second watermark W2 is used. (FIG. 4 shows elements identical to those used in FIG. 1A, or similar, and thereby having reference numbers similar to those of FIG. 1A with the letter “a” appended.)

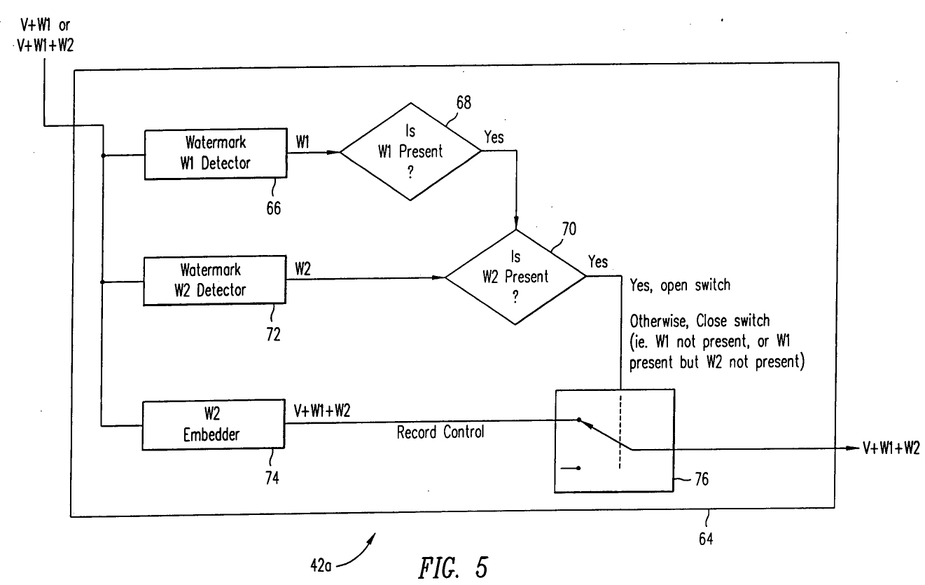

In the FIG. 4 system, when the consumer selection 61 is to view (but not record), the analog video signal output from the STB 34a is No-More-Copy: V+W1+W2. When the consumer selection 61 is to view and record, the video signal output from the STB 34a is Copy-Once: V+W1. Under these circumstances, the record control portion 64 of the associated recorder 42a operates as shown in detail in FIG. 5. (The remainder of recorder 429 is conventional.)

A watermark W1 detector 66 first detects watermark W1. If no watermark W1 is found, then recording (copying) is allowed since it is assumed free-copying is available or the content has no copyright restrictions. If watermark W1 is detected at 68, then the watermark W2 detector 72 detects watermark W2. If W2 is not detected, then recording is allowed since this defines the one-copy-allowed state. The system “fails safe” in that recording is allowed. Note that W is typically some predetermined function of the active video. The fail safe provision is so that the user is not unnecessarily inconvenienced by false positive watermark detections. In general, watermarks are “woven into the fabric” of the video image. Removing them without degrading the base active video content is very difficult.

If W2 is detected along with W1 at 72, then no recording is allowed since this defines the no-more copies state. This is accomplished by controlling switch 76, which in this case (yes from comparator 70) is set to be open. Otherwise (recording permitted) switch 76 is closed and video signal V+W1+W2 from W2 embedder 74 is output from switch 76 to be recorded by the remaining (not shown) conventional portions of recorder 42a. If the video signal input to the recorder 42a has W1 but no W2 and is recorded on the media 46a, then the watermark W2 is embedded in the video signal prior to recording on the media 46a.

Also, it should be recognized that in FIG. 5, while separate detectors 66, 72 are shown for W1 and W2, these may in fact be implemented in the same functional hardware (or software) element with internal reconfiguration as to allow differentiation of W1 and W2. This implementation is readily achieved by one skilled in the art. Playback of media using this embodiment is simpler but it provides a lower level of security since no checking or detection of the watermarks is required. Also, in many cases a compliant recorder will be coupled to the player and will thereby prevent subsequent copies from being generated. A system without this coupling still has value since record control can still provide value even without the added value of play control.

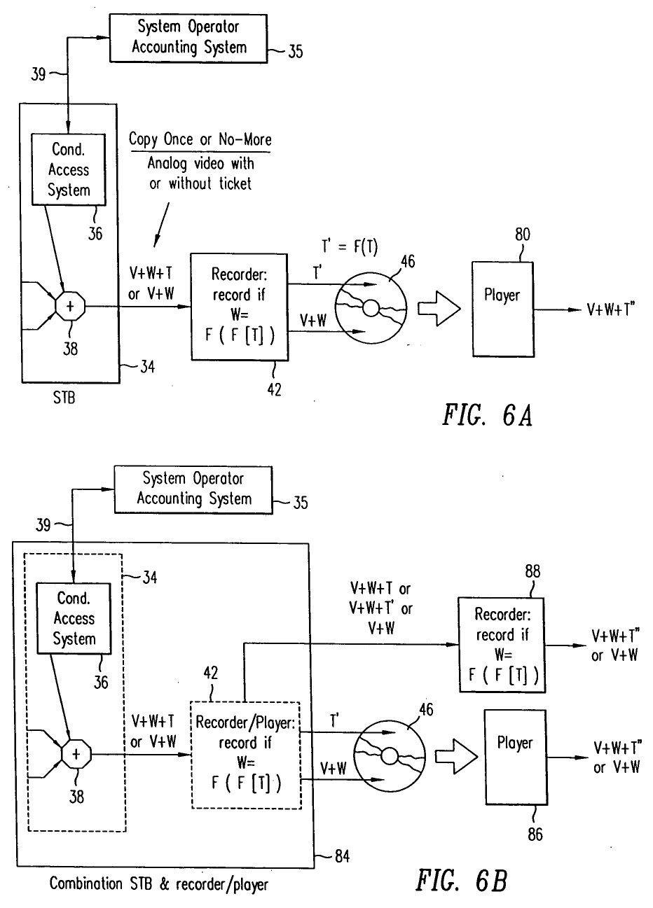

While the above described systems are disclosed in the context of separate devices for the set top box (STB) and the recorder, there is nothing to preclude the functionality of both these devices being integrated into a single apparatus. FIG. 6A shows the system as described above using the same reference numbers, but also showing the compliant player 80, which outputs as shown when playing the media 46, the video with the watermark and the ticket (V+W+T″).

FIG. 6B shows a related system having the STB 34 combined with the recorder 42 in a single apparatus 84. As shown, the output signal stream from the recorder/player 42 may be applied to a recorder 88 if W=F(F(T)). Similarly, the media 46 may be played on player 86 outputting the video stream as shown, which is the video with the watermark and ticket (V+W+T″) or merely the video with the watermark (V+W).

It is apparent that the systems of FIGS. 6A and 6B may be used in the above-described system employing the above-described first watermark and second watermark method for controlling recording.

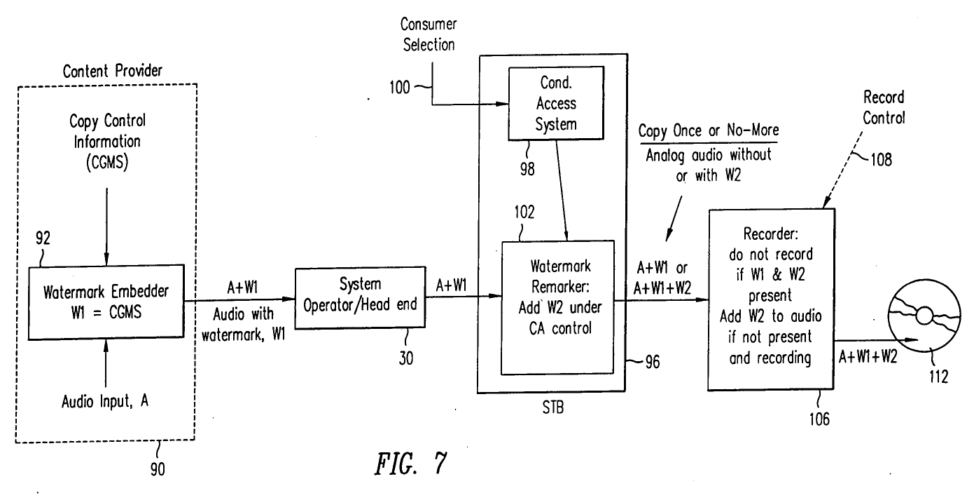

While the above disclosure is directed to video, a similar approach using the first watermark and second watermark may be applied to controlling recording of audio. Hence FIG. 7 shows a system in many respects similar to that of FIG. 4, however being adapted for providing enhanced audio distribution with the possibility of paying to record. The only structure labeled identically in FIG. 7 to FIG. 4 is the system operator headend 30. The other structures, although somewhat similar, have been redesignated to indicate that in this case they are adapted for audio purposes.

Hence the content provider 90, which is the source of the audio material, generates copy control information CGMS which is applied to the input terminal of a watermark embedder 92, to the other terminal of which is applied ordinary audio input signal A. The resulting output audio with watermark A+W1 is communicated, via conventional channels, to the system operator headend 30. From there, the audio signal A+W1 is sent over, for instance, the satellite or cable television distribution system to the STB 96. STB 96 includes a conditional access system 98 to which is applied a consumer selection on line 100.

The STB 96 also includes a watermark remarker 102 which adds watermark W2 under control of conditional access system 98. The watermark remarker 102 then outputs the watermarked audio stream in one of two forms. One form is the copy-once and the other is copy-no-more. In other words, the two forms are A+W1 or A+W1+W2, the analog audio A with or without watermark W2 but always including watermark W1. The associated compliant recorder 106 receives this analog audio signal, and under control of its record control 108, does not record if W1 and W2 are present and adds W2 to the audio if it is not present and recorder 106 is in the recording mode, thereby outputting audio stream. A+W1+W2 to record on associated media 112.

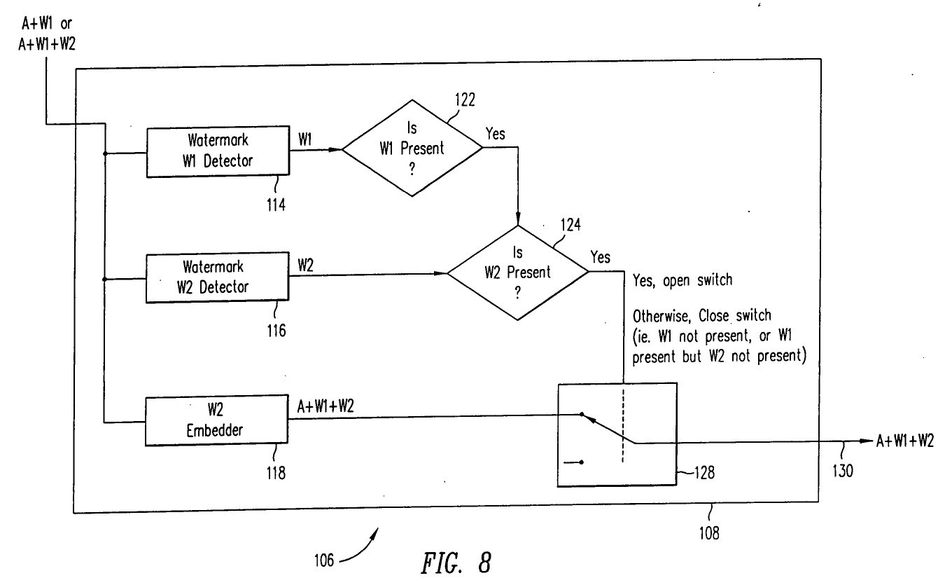

FIG. 8 shows a block diagram of recorder 106 with further detail, showing how the record control portion 108 of audio recorder 106 includes a watermark W1 detector 114, a watermark W2 detector 116, and a watermark W2 embedder 118. The signal output from watermark W1 detector 114 is the indication of watermark W1 being present at 122. This is logically combined at 124 with the indication of whether watermark W2 is present. Only if both watermark are present is switch 128 opened, thereby preventing recording; otherwise switch 128 is closed thereby communicating the input audio with the added watermarks A+W1+W2 on the output terminal 130 of record control portion 108. It is to be understand that FIG. 8 only shows the record control portion 108 of recorder 106, the remaining portions which are not illustrated being the conventional recording portions.

This disclosure is illustrative and not limiting; further modifications will be apparent to one skilled in the art and are intended to fall within the scope of the appended claims. For instance, the present system and method are readily applied to TV and video following various standards.

1-49. (canceled)

50. A method of controlling copying of a video signal, comprising:
receiving at a cable television or direct broadcast satellite set top box a video signal having an embedded watermark and data in a predetermined video line of the video signal in a blanking interval, the predetermined video line carrying parental blocking data according to an established television standard, the data being associated with the watermark;
selecting at the set top box by a user a subsequent use of the video signal in terms of enabling or not enabling recording; and
depending on the selected use, transmitting the video signal with the watermark and with or without the data being present to a television receiver or video recorder, whereby subsequent recording of the video signal is enabled with particular video recorders only if the data is present.

51. The method of claim 50, wherein the associated data is a cryptographic value.

52. The method of claim 51, wherein the cryptographic value is a hash function of a seed, and the watermark is the hash function of the hash function of the hash function of the seed.

53. The method of claim 50, wherein the predetermined video line is video line 21.

54. The method of claim 50, wherein the predetermined video line is field 2, line 21.

55. The method of claim 50, wherein the data extends over at least four fields of the video signal and includes at least 64 bits.

56. The method of claim 50, wherein the data extends over a plurality of fields of the video signal.

57. A set top box for connection to a television receiver or video recorder, for receipt of a video signal from a cable or direct broadcast satellite television system, the set top box comprising:
an input terminal adapted to receive the video signal having an embedded watermark and data in a predetermined video line of the video signal in a blanking interval, the predetermined video line carrying parental blocking data according to an established television standard, the data being associated with the watermark;
a conditional access control having a control terminal for receiving a user selection of a subsequent use of the video signal in terms of enabling or not enabling recording; and
a combiner having a control terminal coupled to an output terminal of the conditional access control and receiving the video signal from the input terminal, and having an output terminal, wherein the combiner outputs the video signal with the watermark and with or without the data being present to the television receiver or video recorder, in response to the conditional access control, whereby subsequent recording of the video signal is enabled with particular video recorders only if the data is present.

58. The set top box of claim 57, wherein the watermark is the hash function of the hash function of the hash function of a seed and the data is a function of the seed.

59. The set top box of claim 57, further comprising:
a connection to an uplink, and wherein the conditional access control transmits to the uplink an indication of user selection.

60. The set top box of claim 57, wherein the associated data is a cryptographic value.

61. The set top box of claim 57, further comprising a video recorder coupled to record the output video signal.

62. The set top box of claim 57, wherein the data extends over at least four fields of the video signal and includes at least 64 bits.

63. The set top box of claim 57, wherein the video line is field 2, line 21.

64. The set top box of claim 57, wherein the data extends over a plurality of fields of the video signal.
